(19) United States
(12) Patent Application Publication
(10) Pub. No.: US 2010/0193116 A1
(43) Pub. Date: Aug. 5, 2010

(54) METHOD FOR MANUFACTURING A COMPOSITE MATERIAL HAVING REDUCED MECHANOSORPTIVE CREEP, THE COMPOSITE MATERIAL, USE OF THE METHOD AND THE COMPOSITE MATERIAL

(75) Inventors: Kristofer Gamstedt, Stockholm (SE); Hannes Vomhoff, Taby (SE); Tommy Iversen, Djursholm (SE); Fredrik Berthold, Djursholm (SE); Tom Lindstrom, Sollentuna (SE); Anders Stenman, Johanneshov (SE); Mikael Lindstrom, Saltsjo-Duvnas (SE); Petri Makela, Skondal (SE); Kristina Wickholm, Stockholm (SE)

Correspondence Address: YOUNG & THOMPSON, 209 Madison Street, Suite 500, Alexandria, VA, 22314, US

(73) Assignee: INNVENTIA AB, Stockholm (SE)

(21) Appl. No.: 12/668,046

(22) PCT Filed: Jul. 4, 2008
(86) PCT No.: PCT/SE2008/050837

§ 371 Date: Apr. 6, 2010

(30) Foreign Application Priority Data
Jul. 12, 2007 (SE) 0701729-6

(51) Int. Cl. B29C 43/30

(52) U.S. Cl. 156/246

(57) ABSTRACT

A method for manufacturing a composite material having reduced mechanosorptive creep includes the following steps:

a) mixing fibers of a lignocellulosic material with a thermoplastic material where the thermoplastic material is in fiber form; b) adding the mixture made in step a) onto a wet web, thus forming a composite material; and c) hot pressing of the composite material. The composite material having reduced mechanosorptive creep being the manufacturing result of the method, and the use of the method and the composite material are described.

The present invention concerns a method for manufacturing a composite material having reduced mechanosorptive creep comprising a fibre material and a thermoplastic material in fibre form. The invention also relates to the composite material and use of the method and the composite material.

The term “thermoplastic”, when used in the following text, includes all polymeric compounds and combinations of polymeric compounds having a melting point below their degradation temperature. Furthermore, the term thermoplastics should be understood to also encompass biodegradable, recyclable and naturally occurring polymeric compounds.

### BACKGROUND

Composite materials containing both lignocellulosic material and plastic material are known. There is known to be problems when manufacturing, forming and using these materials. One problem is the rigidity, the stability, of these materials. Composite materials containing both lignocellulosic material and plastic material are not rigid enough. Another problem with these materials is the risk of creep.

When discussing the deformation of paper being under load one can discern two different creep phenomena;

1) Creep, defined as the time-dependent strain occurring when solids are subjected to an applied stress. Creep is thus a property that all material exhibit. There usually exist a close relationship between the stiffness of a material and the creep of the material, and
2) Mechanosorptive creep—that is the large deformation that can occur under the combined action of load and varied humidity.

The prior art has shown the use of cross-linking chemicals as a method to decrease mechanosorptive creep in paper (Caulfield Tappi J., 77(3)(1994)205). However, this technique usually also results in a more brittle material with decreased folding endurance (Horie D., Biermann C., Tappi J., 77(8)(1994)135). Other methods used include the addition of large amounts of wax and this causes other problems regarding the wax itself and its working and functioning.

One purpose of this invention is to provide a method for manufacturing a composite material that is more rigid and where the mechanosorptive creep is reduced and the composite material itself, comprising a fibre material and a thermoplastic material in fibre form, that is more rigid and where the mechanosorptive creep is reduced. The invention also deals with use of both the method and the composite material.

This purpose is enabled by a method for manufacturing a composite material having reduced mechanosorptive creep according to the invention comprising the technical features of claim 1, a composite material having reduced mechanosorptive creep being the manufacturing result of the method according to claim 1 comprising the technical features of claim 16, the use of the method according to claim 1 comprising the technical features of claim 26 and the use of the composite material according to claim 16 comprising the technical features of claim 27.

### SUMMARY OF THE INVENTION

The present invention solves one or more of the above problems by providing, according to a first aspect, a method for manufacturing a composite material having reduced mechanosorptive creep comprising the following steps:
a) mixing fibers of a lignocellulosic material with a thermoplastic material where the thermoplastic material is in fiber form,
b) adding the mixture made in step a) onto a wet web, thus forming a composite material and
c) hot pressing of the composite material.

The present invention also provides, according to a second aspect, a composite material having reduced mechanosorptive creep obtainable by the method according to the first aspect.

The present invention also provides, according to a third aspect, use of the method of the first aspect for manufacturing a composite material to be used in writing-paper, corrugated products, molded/moulded paper products, bag liners, paper board, card board and/or carton.

The present invention also provides, according to a fourth aspect, use of the composite material of the second aspect in writing-paper, corrugated products, molded/moulded paper products, bag liners, paper board, card board and/or carton.

### DETAILED DESCRIPTION OF THE INVENTION

According to a preferred embodiment of the first aspect of the invention the mixing of fibers of a lignocellulosic material with fibers of thermoplastic material is performed either during wet forming, preferably followed by a dewatering step, or either during molding/moulding.

Today, when manufacturing composite materials, injection moulded thermoplastic polymer matrixes composites containing organic or inorganic fillers, e.g. lignocellulosic material, the organic or inorganic fillers are mixed with a thermoplastic material in either an extruder or a compounder to produce granules that subsequently are fed into an injection moulding equipment to be used during an injection moulding step. As the lignocellulosic material has low density and the fibres of the lignocellulosic material are strongly attached to each other the mixing is complicated and requires lot of energy to be successful.

By using wet forming when mixing fibers of the lignocellulosic material with fibers of the thermoplastic material a high degree of disperse is obtained without having to melt the thermoplastic material. Compounding is made easier or will not be needed at all and a full manufacturing step can by that be deleted. Also the machines used can be deleted. This gives the result that time, energy and investment money can be saved.

Successful tests have been made where wet formed material has been feed directly into a injection-mould.

By wet forming, mixing, the materials and from that form a paper, semi-finished articles, goods, having an exact composition can be manufactured. The semi-finished articles can then be manufactured to the end articles anywhere suitable and at any time.

Stratified sheet manufacturing can be used for adding pigment, softener and/or other additives in a high precision. Also the composition, the structure, of the material is easier to control as the mixing is made in a more precise and predictable way.

The fibers of thermoplastic material has a length of 0.5-10 mm, preferably 1-5 mm, and a width of 5-200 micrometer, preferably 10-100 micrometer.

According to a preferred embodiment of the first aspect of the invention the wet web is a paper web. The fibers of the thermoplastic material are preferably added to the fibers of the lignocellulosic material just before the mixture is added onto a wet web. The composite material is in this stage not consolidated and is in the form of a plain material, perhaps rolled onto a cylinder. The material needs to be further treated to become consolidated and to reach its definite form and function.

According to a preferred embodiment of the first aspect of the invention the method comprises a step d) heat treating the composite material. The heat treating consolidates the web and the mixture of fibers of a lignocellulosic material and fibers of thermoplastic material to a firm consolidated composite material.

According to a preferred embodiment of the first aspect of the invention the method comprises a step e) laying the composite material in layers, thus forming a composite material having two or more layers.

According to a preferred embodiment of the first aspect of the invention the pressing further consolidates the web and the mixture of fibers of a lignocellulosic material and fibers of thermoplastic material to a firm consolidated composite material.

According to a preferred embodiment of the first aspect of the invention the pressing is performed by using two surfaces which are heated at a temperature close to the melt point of the thermoplastic material.

According to a preferred embodiment of the first aspect of the invention the mixture comprising fibers of the lignocellulosic material and the thermoplastic material is preheated before the pressing.

According to a preferred embodiment of the first aspect of the invention the pressing is performed, done, using a high value of the pressing force. A preferably value is to be found above 50 kPa. Experiments have been made using different press forces having very satisfying results (see FIG. 1 on page 12). The high pressing force gives the result that the addition/mixture of the materials is further consolidated and appears as one homogeneous material having the targeted functions and qualities.

The heating and pressing can be performed together in one step. A drying step can precede the pressing, the heating/pressing. The drying can also be performed during the pressing.

According to a preferred embodiment of the first aspect of the invention the thermoplastic material is a poly hydroxy alkanoate.

According to a preferred embodiment of the first aspect of the invention the thermoplastic material is selected from the group of PE, PP, PLA, PHV, PHA, PHB, CAP, CAB. The material can also be a mixture of two or more of these materials.

According to a preferred embodiment of the first aspect of the invention the thermoplastic material is PLA.

According to a preferred embodiment of the first aspect of the invention wherein the fibers of the lignocellulosic material is mixed with the thermoplastic material where the thermoplastic material constitutes between 0.5 and 90% by weight of the mixture.

According to a preferred embodiment of the first aspect of the invention wherein the fibers of the lignocellulosic material is mixed with the thermoplastic material where the thermoplastic material constitutes between 1 and 25% by weight of the mixture.

According to a preferred embodiment of the first aspect of the invention wherein the fibers of the lignocellulosic materials mixed with the thermoplastic material where the thermoplastic material constitutes between 1 and 10% by weight of the mixture.

According to a preferred embodiment of the first aspect of the invention wherein the fibers of the lignocellulosic materials mixed with the thermoplastic material where the thermoplastic material constitutes between 30 and 70% by weight of the mixture.

As the mixture comprising fibers of the lignocellulosic material and fibers of the thermoplastic material has a high degree of disperse and the fact that the thermoplastic material does not have to be heated, when the mixing is made using wet forming, it is possible to use a higher amount of thermoplastic material.

According to a preferred embodiment of the second aspect of the invention the composite material comprises a paper web.

According to a preferred embodiment of the second aspect of the invention the thermoplastic material is a poly hydroxy alkanoate.

According to a preferred embodiment of the second aspect of the invention the thermoplastic material is selected from the group of PE, PP, PLA, PHV, PHA, PHB, CAP, CAB. The material can also be a mixture of two or more of these materials.

According to a preferred embodiment of the second aspect of the invention the thermoplastic material is PLA.

According to a preferred embodiment of the second aspect of the invention the composite material is in the form of a sheet.

According to a preferred embodiment of the second aspect of the invention wherein the thermoplastic material constitutes between 0.5 and 90% by weight of the mixture.

According to a preferred embodiment of the second aspect of the invention wherein the thermoplastic material constitutes between 1 and 25% by weight of the mixture.

According to a preferred embodiment of the second aspect of the invention wherein the thermoplastic material constitutes between 1 and 10% by weight of the mixture.

According to a preferred embodiment of the second aspect of the invention wherein the thermoplastic material constitutes between 30 and 70% by weight of the mixture.

As the mixture comprising fibers of the lignocellulosic material and fibers of the thermoplastic material has a high degree of disperse and the fact that the thermoplastic material does not have to be heated, when the mixing is made using wet forming, it is possible to use a higher amount of thermoplastic material and by that end up with a composite material comprising a higher amount of thermoplastic material.

PLA is a biodegradable thermoplastic derived from lactic acid. It provides good aesthetics as it is shiny and has high clearness. PLA is stiff and brittle and needs modifications for most practical applications. The stiffness of PLA comes into good work together with the fibers of the lignocellulosic material providing a more flexible material reducing the negative aspect of the brittleness of PLA.

PLA is an aliphatic polyester featuring easy processability in most equipment. It can be processed like most thermoplastics into fibres, films, thermoformed or injection moulded.

PLA is made of polylactic acid, a repeating chain of lactic acid, and can be obtained on the basis of renewable starch containing resources, e.g. corn, wheat or sugar beat, by fermentation, or by chemical synthesis of non-renewable resources.

If PLA is composted it biodegrades. Lactic acid undergoes a 2-step degradation process. First, the moisture and heat in the compost pile attack the PLA polymer chains and split them apart, creating smaller polymers, and finally, lactic acid. Microorganisms in compost and soil consume the smaller polymer fragments and lactic acid as nutrients. Since lactic acid is widely found in nature, a large number of organisms metabolize lactic acid. At a minimum, fungi and bacteria are involved in PLA degradation. The end result of the process is carbon dioxide, water and also humus, a soil nutrient. This degradation process is temperature and humidity dependent. If composted properly it takes 3-4 weeks for complete degradation.

The lignocellulosic fibres that may be used with the present invention include all types of wood-based fibres, such as bleached, half-bleached and unbleached sulphite, sulphate and soda pulps, together with unbleached, half-bleached and bleached mechanical, thermo-mechanical, chemo-mechanical and chemo-thermo-mechanical pulps, and mixtures of these. Both new fibres and recycled fibres can be used with the present invention, as can mixtures of these. Pulps from both softwood and hardwood trees can be used, as can mixtures of such pulps. Pulps that are not based on wood, such as cotton linters, regenerated cellulose, kenaf and grass fibres may also be used with the present invention.

The composite material manufactured by the method according to the first aspect of the present invention and the composite material according to a preferred embodiment of the second aspect of the invention may be used when manufacturing any product where the presence of mechanosorptive creep is not wanted, products where it is wanted to have reduced mechanosorptive creep in the material. The composite material according to a preferred embodiment of the second aspect of the invention may be used in writing-paper, corrugated products, moulded paper products, bag liners, paper board, card board and/or carton.

Preferred features of each aspect of the invention are as for each of the other aspects mutatis mutandis. The prior art documents mentioned herein are incorporated to the fullest extent permitted by law. The invention is further described in the following examples in conjunction with the appended figures, which do not limit the scope of the invention in any way. Embodiments of the present invention are described in more detail with the aid of examples of embodiments and figures, the only purpose of which is to illustrate the invention and are in no way intended to limit its extent.

### EXAMPLES

The following examples are given, not restrictively, to illustrate the invention. Example 1 relates to the production of paper like composites having improved properties, example 2 relates to the production of injection molded articles without the need of a compounding step and example 3 describes the effect of pressing pressure on mechanosorptive creep.

### Regarding Example 1

A laboratory made sulfate softwood pulp (spruce, kappa 34) was used. PLA fibers (PL01 5 mm, 1.7 dtex) where purchased from Unitika, Japan.

Sulphate fibre/PLA sheets were produced using a dynamic sheet former. The drum rotated 1500 min⁻¹ and the pressure was 2.8 bar. The consistency of fibre suspensions was 1%. The PLA fibers were suspended in water and added to the pulp suspension immediately before sheet formation. After formation, sheets were roll pressed twice, first at 1 bar and a second time at 5 bar pressure. The sheets were dried under restraint at 100° C. for 16 minutes and stored in plastic bags before use. Grammage of produced sheets was 100 g/m². Sheets containing 0, 5, 25 and 40 wt % PLA were produced. Two separate sets of sheet were produced (experiment one and two), see table 1.

From the sheets, pieces (13*21 cm) were cut and pressed at 7 MPA (dial value) at 175° C. using a Servitec Polystat 200T. In order to prevent the sample from sticking to the heated surfaces they are placed either between plastic films (experiment 2) or aluminium foil (experiment 1).

Standard strips (13*1.5 cm) were cut from large pressed samples. The tensile properties were determined using an Alvetron TH (Lorentzen o Wettre) standard tensile tester. The gauge length was 10 cm and testing speed 1%/min.

Mechanosorptive creep was determined by measuring the strain under constant load as the humidity was varied. Samples were tested both in MD and CD under compressive and tensile loads between 5 and 20 N. The humidity was cycled three times between 50 and 90% RH. A whole cycle was 400 minutes.

TABLE 1
Observed strain, calculated reduction of
strain and amplitude of tested samples.

| | max strain | | | amplitude |
|---|---|---|---|---|
| | 3rd cycle (′100) | | % reduction | (Δstrain) |
| Experiment 1 | | | | |
| 10 N tensile load | | | | |
| 0% PLA MD (n = 2) | 32.42 | (3.68) | — | 0.14 |
| 5% PLA MD (n = 2) | 16.44 | (3.41) | 49.0 | 0.08 |
| 25% PLA MD (n = 3) | 15.66 | (1.22) | 52.0 | 0.05 |
| 40% PLA MD (n = 3) | 12.38 | (2.61) | 62.0 | 0.04 |
| 5 N compressive load | | | | |
| 0% PLA MD (n = 1) | −10.65 | | — | 0.13 |
| 5% PLA MD (n = 1) | −9.58 | | 10.05 | 0.09 |
| 25% PLA MD (n = 1) | −8.01 | | 24.79 | 0.08 |
| 40% PLA MD (n = 1) | −4.98 | | 53.24 | 0.04 |
| Experiment 2 | | | | |
| 10 N tensile load | | | | |
| 0% PLA MD (n = 3) | 38.8 | (3.5) | — | 0.10 |
| 5% PLA MD (n = 3) | 29.9 | (2.9) | 23.0 | 0.10 |
| 25% PLA MD (n = 3) | 16.4 | (0.8) | 57.7 | 0.04 |
| 40% PLA MD (n = 3) | 15.2 | (0.9) | 60.9 | 0.05 |
| 20 N tensile load | | | | |
| 0% PLA MD (n = 2) | 35.4 | (1.6) | — | 0.11 |
| 5% PLA MD (n = 3) | 30.8 | (4.2) | 12.9 | 0.10 |
| 25% PLA MD (n = 2) | 24.4 | (2.4) | 38.1 | 0.07 |
| 40% PLA MD (n = 3) | 19.4 | (3.2) | 45.2 | 0.05 |
| 10 N tensile load | | | | |
| 0% PLA CD (n = 3) | 92.0 | (51.6) | — | 0.19 |
| 5% PLA CD (n = 2) | 86.3 | (7.8) | 6.20 | 0.21 |
| 25% PLA CD (n = 2) | 81.8 | (11.1) | 11.09 | 0.23 |
| 40% PLA CD (n = 2) | 60.4 | (4.7) | 34.35 | 0.15 |
| 5 N compressive load | | | | |
| 0% PLA CD (n = 3) | failed | | — | |
| 5% PLA CD (n = 2) | failed | | — | |
| 25% PLA CD (n = 2) | −49.7 | (20.6) | — | 0.16 |
| 40% PLA CD (n = 2) | −4.8 | (0.8) | — | 0.21 |
| 10 N compressive load | | | | |
| 0% PLA MD (n = 3) | −27.6 | (5.1) | — | 0.1 |
| 5% PLA MD (n = 3) | −26.7 | (3.0) | 3.26 | 0.08 |
| 25% PLA MD (n = 2) | −8.28 | (1.1) | 70.00 | 0.03 |
| 40% PLA MD (n = 2) | −18.86 | (4.3) | 31.67 | 0.02 |
| 20 N compressive load | | | | |
| 0% PLA MD (n = 3) | failed | | — | — |
| 5% PLA MD (n = 3) | failed | | — | — |
| 25% PLA MD (n = 2) | −21.1 | (6.9) | — | 0.03 |
| 40% PLA MD (n = 2) | −47.34 | (0.9) | — | 0.03 |

MD = machine direction, CD = cross machine direction

Measurements of dry and wet tensile properties show that higher mechanical properties are achieved under wet conditions by the mixing in of PLA fibres. This was especially true for the strength but also for stiffness, see Table 2.

Based on the results from this study we can say that it is possible to significantly decrease the mechanosorptive creep of pulp fibre based sheets by the addition of PLA fibres. The sheets need to be thermally treated above the melting point of PLA to achieve this effect. Mechanosorptive creep is a central property of paper and board that influence many important properties.

TABLE 2
Determined dry and wet properties of tested sheets.

| | | strength | strength | ratio | stiffness | stiffness | ratio |
|---|---|---|---|---|---|---|---|
| exp. no. | % PLA | (dry) | (wet) | (wet/dry) % | (dry) | (wet) | (wet/dry) % |
| 1 | 0 | 6.55 | 0.94 | 14.35 | 8.90 | 1.50 | 16.85 |
| | 5 | 8.45 | 1.72 | 20.36 | 10.10 | 1.80 | 17.82 |
| | 25 | 9.38 | 5.34 | 56.93 | 10.30 | 2.60 | 25.24 |
| | 40 | 7.37 | 6.15 | 83.45 | 7.90 | 3.10 | 39.24 |
| 2 | 0 | 13.10 | 1.10 | 8.40 | 12.20 | 1.50 | 12.30 |
| | 5 | 16.20 | 2.00 | 12.35 | 10.80 | 1.40 | 12.96 |
| | 25 | 18.90 | 6.70 | 35.45 | 10.70 | 2.20 | 20.56 |
| | 40 | 15.70 | 10.00 | 63.69 | 9.80 | 3.00 | 30.61 |

### Regarding Example 2

Experiment 2 was performed in order to verify the usefulness of wet formed composite material in injection moulding.

The wet compounded material was made using unbleached spruce sulphate pulp and PLA (PL01, 5 mm, 1.7 dtex, Unitika, Japan). Either pulp fibres or PLA fibres were beaten together for 4 000 revs, 4% consistency, and thereafter dried in room temperature; or PLA fibres and pulp fibres were beaten separately and mixed afterwards. The material was subsequently either dried and torn into small pieces by hand or formed into wet laid mats. The mats were also dried prior to use.

Two different qualities were made; 40% PLA contents and 70% PLA contents.

The 70% PLA content pulp was extruded to granulates in a ZSK 25 WLE twin screw extruder (Krupp Werner & Pfleider, Dinkelsbühl, Germany). The extruder held a temperature of 190° C. and a screw velocity of 350 rpm. Two different processing lengths were tried out. For granule1 about ⅖ of the screw was used while for granule2 ⅘ of the screw was used. The material was hand injected using the lowest possible speed.

Six different approaches were tried in the injection moulding using an ENGEL CC80 (Engel, Schwertberg, Austria) (table 3). A temperature profile of 185° C. in the mouthpiece and 180° C. in zone 1 to 3 was held during the trials. For the pulps and sheets manual injection was used. The machine was equipped with a tool for production of standard dog bones.

TABLE 3
Materials used in injection moulding.

| Material designation | Description |
|---|---|
| 40% | 40% PLA pulp, direct compression moulding |
| 70% | 70% PLA pulp, direct compression moulding |
| 40% | 40% PLA sheet, direct compression moulding |
| 70% | 70% PLA sheet, direct compression moulding |
| Granule1 | Extruded 70% PLA granulates, short path |
| Granule2 | Extruded 70% PLA granulates, long path |

Produced dog bones all had satisfactory surface without any noticeable variation in appearance showing and even mixing of fibres and polymer. Breaking of produced dogbones also showed that the composite was homogeneous without any observable differences in composition. This experiment show that the “wet compounding” technique can be used to mix cellulosic/pulp fibres and thermoplastic fibres into an intermediate material that can be fed into an injection moulding machine without the need for a separate palletizing step.

### Regarding Example 3

Standard lab sheets were prepared from a mixture of 80% by weight industrially made softwood kraft pulp (kappa 42) and 20% by weight PLA fibers (PL01 5 mm, 1.7 dtex) (Unitika, Japan) according to ISO 5269-1. The prepared sheets were heat treated at 180° C.

Different constant magnitudes of pressure were applied to the sheets during the heat treatment. Mechanosorptive creep experiments were performed at a temperature of 23° C. and an ambient relative humidity that was cycled between 50% and 90%. The experimental data was used to determine the isocyclic creep stiffness (Panek et. al, 2004) of the sheets. The results (FIG. 1) clearly show that the isocyclic creep stiffness of the sheets was enhanced by increasing the pressure during the heat treatment. The results further show that a lower threshold in pressure had to be exceeded during the heat treatment in order to achieve a substantial positive effect of the PLA fibres addition on the mechanosorptive creep properties of the sheets.

Information regarding principles of evaluation for the creep of paperboard in constant and cyclic humidity is to be found in an article having the same title and written by Panek J, Fellers C and Haraldsson T, Nord. Pulp Pap. Res. J, 19 (2), pp 155-163, 2004.

Various embodiments of the present invention have been described above but a person skilled in the art realizes further minor alterations, which would fall into the scope of the present invention. The breadth and scope of the present invention should not be limited by any of the above-described exemplary embodiments, but should be defined only in accordance with the following claims and their equivalents. For example, any of the above-noted methods can be combined with other known methods. Other aspects, advantages and modifications within the scope of the invention will be apparent to those skilled in the art to which the invention pertains.

1. A method for manufacturing a composite material having reduced mechanosorptive creep comprising the following steps:
a) mixing fibers of a lignocellulosic material with a thermoplastic material where the thermoplastic material is in fiber form,
b) adding the mixture made in step a) onto a wet web, thus forming a composite material and
c) hot pressing of the composite material using a minimum pressure force of 50 kPa.

2. A method according to claim 1 wherein the mixing in step a) is performed either during wet forming, preferably followed by a dewatering step, or during moulding.

3. A method according to claim 1 wherein the wet web is a paper web.

4. A method according to claim 1 comprising a step d) heat treating the composite material.

5. A method according to claim 1 comprising a step e) laying the composite material in layers, thus forming a composite material having two or more layers.

6. A method according to claim 1 wherein the pressing is performed by using two surfaces which are heated at a temperature close to the melt point of the thermoplastic material.

7. A method according to claim 1 wherein the mixture comprising fibers of the lignocellulosic material and the thermoplastic material is preheated before the pressing.

8. A method according to claim 1 wherein the thermoplastic material is a poly hydroxy alkanoate.

9. A method according to claim 1 wherein the thermoplastic material is selected from the group of PE, PP, PLA, PHV, PHA, PHB, CAP, CAB.

10. A method according to claim 1 wherein the thermoplastic material is PLA.

11. A method according to claim 1 wherein the fibers of the lignocellulosic material is mixed with the thermoplastic material where the thermoplastic material constitutes between 0.5 and 90% by weight of the mixture.

12. A method according to claim 1 wherein the fibers of the lignocellulosic material is mixed with the thermoplastic material where the thermoplastic material constitutes between 1 and 25% by weight.

13. A method according to claim 1 wherein the fibers of the lignocellulosic materials mixed with the thermoplastic material where the thermoplastic material constitutes between 1 and 10% by weight.

14. A method according to claim 1 wherein the fibers of the lignocellulosic materials mixed with the thermoplastic material where the thermoplastic material constitutes between 30 and 70% by weight.

15. A composite material having reduced mechanosorptive creep being the manufacturing result of the method according to claim 1.

16. A composite material according to claim 15 where the wet web is a paper web.

17. A composite material according to claim 15 wherein the thermoplastic material is a poly hydroxy alkanoate.

18. A composite material according to claim 15 wherein the thermoplastic material is selected from the group of PE, PP, PLA, PHV, PHA, PHB, CAP, CAB.

19. A composite material according to claim 15 wherein the thermoplastic material is PLA.

20. A composite material according to claim 15 in the form of a sheet.

21. A composite material according to claim 15 wherein the thermoplastic material constitutes between 0.5 and 90% by weight of the mixture.

22. A composite material according to claim 15 wherein the thermoplastic material constitutes between 1 and 25% by weight.

23. A composite material according to claim 15 wherein the thermoplastic material constitutes between 1 and 10% by weight.

24. A composite material according to claim 15 wherein the thermoplastic material constitutes between 30 and 70% by weight.

25-27. (canceled)
